(19) United States
(12) Patent Application Publication
(10) Pub. No.: US 2026/0125114 A1
(43) Pub. Date: May 7, 2026

(54) VEHICLE FRONT STRUCTURE

(71) Applicant: TOYOTA JIDOSHA KABUSHIKI KAISHA, Toyota-shi (JP)

(72) Inventor: Shoji OGIMURA, Toyota-shi (JP)

(73) Assignee: TOYOTA JIDOSHA KABUSHIKI KAISHA, Toyota-shi (JP)

(21) Appl. No.: 19/305,926

(22) Filed: Aug. 21, 2025

(30) Foreign Application Priority Data
Nov. 7, 2024 (JP) 2024-194964

(51) Int. Cl. B62D 25/08

(52) U.S. Cl. CPC B62D 25/084

(57) ABSTRACT

A vehicle front structure includes a tower bar that connects left and right suspension towers in a front portion of a vehicle, and a water-cooled gas cooler that exchanges heat between an air-conditioning refrigerant used in an air-conditioning device and a water-based coolant. The tower bar is a hollow member including a closed cross-sectional shape, and the water-cooled gas cooler is disposed inside the tower bar.

### CROSS-REFERENCE TO RELATED APPLICATION

This application claims priority to Japanese Patent Application No. 2024-194964 filed on Nov. 7, 2024. The disclosure of the above-identified application, including the specification, drawings, and claims, is incorporated by reference herein in its entirety.

### BACKGROUND

### 1. Technical Field

The present specification discloses a vehicle front structure including a heat exchanger that exchanges heat between an air-conditioning refrigerant and water.

### 2. Description of Related Art

In general, an in-vehicle air-conditioning device transfers heat by compressing, expanding, evaporating, and condensing an air-conditioning refrigerant in a process of circulating an air-conditioning refrigerant, thereby generating temperature-adjusted air-conditioning air. In a flow passage of the air-conditioning refrigerant, an air-cooled heat exchanger (for example, an air-cooled condenser or an air-cooled gas cooler) that exchanges heat between the air-conditioning refrigerant and traveling wind is often provided. Furthermore, in recent years, it has also been proposed to provide a water-cooled heat exchanger instead of or in addition to the air-cooled heat exchanger.

For example, Japanese Unexamined Patent Application Publication No. 2017-072309 (JP 2017-072309 A) discloses an air-conditioning system for a vehicle, the air-conditioning system including a water-cooled condenser. In JP 2017-072309 A, the water-cooled condenser functions as a condenser that condenses an air-conditioning refrigerant by cooling the air-conditioning refrigerant with a coolant from a sub radiator. Such a water-cooled condenser can be installed in a location that is not exposed to traveling wind, thereby having high flexibility in terms of installation location, as compared to an air-cooled condenser.

### SUMMARY

Here, most of an air-conditioning device including a heat exchanger is disposed in a power unit compartment in a front portion of a vehicle. In addition to the air-conditioning device, a power source and a radiator are also disposed in the power unit compartment. Therefore, in a case where an air-cooled heat exchanger is disposed in the power unit compartment, issues with space limitations arise, thereby a volume of the air-cooled heat exchanger is difficult to be sufficiently secured. In JP 2017-072309 A, a position where the air-cooled condenser is disposed is not addressed.

Therefore, the present specification discloses a vehicle front structure that can further improve space efficiency of a front portion of a vehicle.

A vehicle front structure disclosed in the present specification includes a tower bar configured to connect left and right suspension towers in a front portion of a vehicle, and
a heat exchanger configured to exchange heat between an air-conditioning refrigerant used in an air-conditioning device and a water-based coolant, in which the tower bar is a hollow member having a closed cross-sectional shape, and
the heat exchanger is disposed inside the tower bar.

With such a configuration, space efficiency of the front portion of the vehicle is further improved.

In this case, the heat exchanger may be
a gas cooler in which a layer of a refrigerant flow passage through which the air-conditioning refrigerant flows and a layer of a water flow passage through which the water-based coolant flows are alternately stacked, and
the heat exchanger may be disposed inside the tower bar in a posture in which a running direction of a flow passage of the air-conditioning refrigerant and a longitudinal direction of the tower bar are substantially parallel to each other.

With such a configuration, a distance of the refrigerant flow passage can be secured, and heat exchange efficiency is improved.

In addition, the gas cooler may be disposed substantially at a center of the tower bar in a vehicle width direction, and
an inlet and an outlet for each of the air-conditioning refrigerant and the water-based coolant may be provided at both ends of the gas cooler in the vehicle width direction.

Many other elements of the air-conditioning device are disposed near the center of the vehicle in the vehicle width direction. Therefore, by disposing the gas cooler at the center in the vehicle width direction and providing the inlets and outlets on both sides thereof, piping connections between the gas cooler and the other elements can be simplified.

In addition, the air-conditioning device may be configured to perform heating using heat transferred from the air-conditioning refrigerant to the water-based coolant in the heat exchanger, and
a space between the heat exchanger and an inner surface of the tower bar may be filled with an insulating material.

With such a configuration, the heat used for the heating is less likely to leak to the outside, and thus efficiency of the air-conditioning device is improved. In addition, by providing the insulating material, vibration of the gas cooler can also be suppressed.

With a technology disclosed in the present specification, the space efficiency of the front portion of the vehicle is further improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view showing disposition of main parts in a front portion of a vehicle;

FIG. 2 is a diagram showing a configuration of an air-conditioning device;

FIG. 3 is a cross-sectional view taken along line III-III in FIG. 1;

FIG. 4 is an exploded perspective view of a main part of a water-cooled gas cooler; and

FIG. 5 is a schematic perspective view of the water-cooled gas cooler.

### DETAILED DESCRIPTION OF EMBODIMENTS

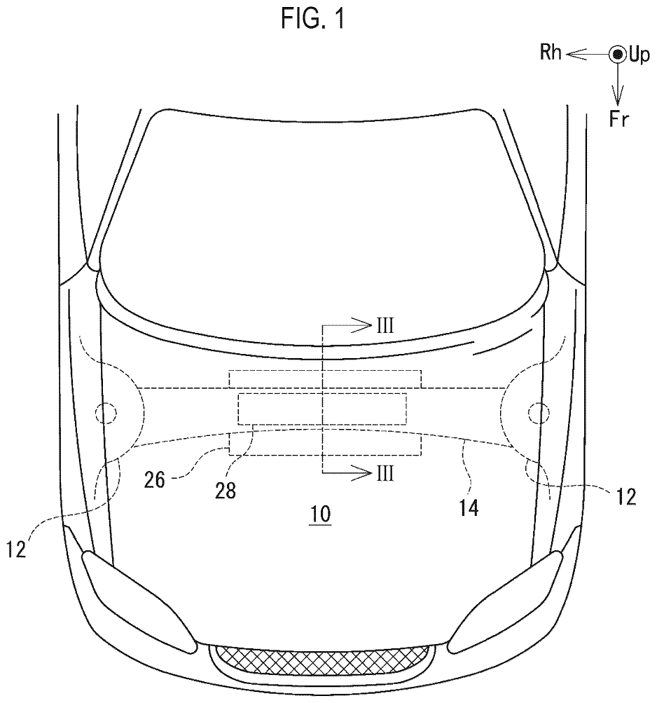

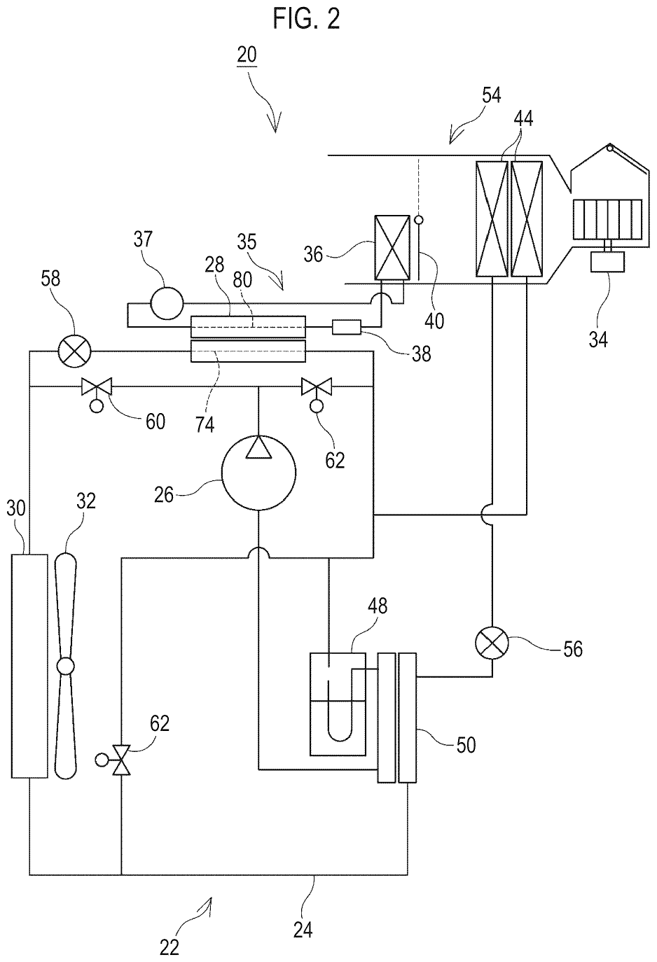

Hereinafter, a vehicle front structure will be described with reference to the drawings. FIG. 1 is a plan view showing disposition of main parts in a front portion of a vehicle. As shown in FIG. 1, a space called a power unit compartment 10 is provided between a front end surface of the vehicle and a vehicle cabin, in other words, below a hood of the vehicle. For example, a power source (not shown), a gear unit (not shown), and an air-conditioning device 20 (see FIG. 2) are disposed in such a power unit compartment 10. The power source is, for example, an engine, an electric motor, or both. In a case of an electrified vehicle, a transaxle in which the gear unit and the electric motor are integrated is disposed in the power unit compartment 10. As described below, the air-conditioning device 20 includes a large number of components such as a compressor 26, an air-cooled gas cooler 30, and an evaporator 44.

In addition, the power unit compartment 10 is also provided with a suspension tower 12 for mounting a front suspension. As shown in FIG. 1, suspension towers 12 are disposed one at each end of the power unit compartment 10 in a vehicle width direction, for a total of two. A tower bar 14 is bridged between the two suspension towers 12. The two suspension towers 12 are connected to each other by the tower bar 14, thereby the rigidity of the vehicle is increased, and the driving stability of the vehicle is improved. Furthermore, various sensors, wiring, and piping are disposed in the power unit compartment 10. That is, in the related art, a large number of relevant components for the vehicle are disposed in the power unit compartment 10.

Next, a configuration of the air-conditioning device 20 disposed in the power unit compartment 10 will be described. FIG. 2 is a diagram showing a configuration of the air-conditioning device 20. The air-conditioning device 20 generates temperature-adjusted air-conditioning air by compressing, expanding, evaporating, and condensing an air-conditioning refrigerant in a process of circulating the air-conditioning refrigerant to transfer heat. In the related art, a fluorine-based refrigerant is commonly used as a refrigerant of the air-conditioning device 20. In the air-conditioning device 20 of the present example, a natural refrigerant is used as an air-conditioning refrigerant. The natural refrigerant is a refrigerant containing a substance generated in nature as a main component, and contains, for example, a carbon compound (for example, carbon dioxide or hydrocarbon) or ammonia as a main component. The carbon compound used as the natural refrigerant is, for example, carbon dioxide (hereinafter, referred to as “CO2”) or hydrocarbon (for example, propane or butane). Such a natural refrigerant has a lower global warming coefficient and a smaller load on the environment than a fluorine-based refrigerant. For example, a global warming coefficient of the fluorine-based refrigerant is approximately 1400, whereas a global warming coefficient of a CO2 refrigerant containing CO2 as a main component is 1 that is very small. Hereinafter, an example in which the CO2 refrigerant is adopted as the natural refrigerant will be described.

The air-conditioning device 20 includes a refrigerant circuit 22 and a blower mechanism 54. The refrigerant circuit 22 is a circuit that generates heat and latent heat by compressing, expanding, condensing, and evaporating the air-conditioning refrigerant in a process of circulating the air-conditioning refrigerant. The heat generated in the refrigerant circuit 22 is used for heating, and the latent heat is used for cooling, respectively. The blower mechanism 54 is a mechanism that blows air taken from the outside of the vehicle or the inside of the vehicle into the inside of the vehicle by cooling or heating the air. Specifically, the blower mechanism 54 includes the evaporator 44, a heater core 36, and a blower fan 34. The evaporator 44 is an evaporator that evaporates an air-conditioning refrigerant having a mist form. Air around the evaporator 44 is cooled by the latent heat generated during the evaporation. The air cooled by the evaporator 44 is sent to the vehicle cabin by the blower fan 34, thereby the vehicle cabin is cooled.

The heater core 36 is a heat exchanger that exchanges heat between hot water flowing through the inside thereof and air therearound. A mode switching door 40 that switches a flow rate of the air passing through the heater core 36 is disposed behind the heater core 36. The mode switching door 40 is closed during cooling operation and is opened during heating operation. In a case where the mode switching door 40 is opened, the air sent from the blower fan 34 is heated by the heater core 36. The heated air is sent to the vehicle cabin, thereby the vehicle cabin is heated.

The refrigerant circuit 22 includes refrigerant piping 24 through which the air-conditioning refrigerant flows. Along the path of the refrigerant piping 24, devices for compressing, expanding, condensing, and evaporating the air-conditioning refrigerant, for example, the compressor 26, the air-cooled gas cooler 30, a water-cooled gas cooler 28, an accumulator 48, and the evaporator 44 are provided. The compressor 26 compresses an air-conditioning refrigerant having a gas form. The air-cooled gas cooler 30 is disposed behind a front grille (not shown). The air-cooled gas cooler 30 is a heat exchanger that exchanges heat between the air-conditioning refrigerant and outside air. A fan 32 for efficiently taking in the outside air is disposed behind the air-cooled gas cooler 30.

The accumulator 48 separates the air-conditioning refrigerant output from the air-cooled gas cooler 30 or the evaporator 44 into a gas phase and a liquid phase, and sends the separated air-conditioning refrigerant to the compressor 26. In addition, the accumulator 48 includes an internal heat exchanger 50 that exchanges heat between the high-temperature air-conditioning refrigerant and the low-temperature air-conditioning refrigerant. Specifically, the internal heat exchanger 50 exchanges heat between the air-conditioning refrigerant flowing from the air-cooled gas cooler 30 toward the evaporator 44 and the air-conditioning refrigerant flowing from the accumulator 48 toward the compressor 26.

The water-cooled gas cooler 28 is a heat exchanger that exchanges heat between the high-temperature air-conditioning refrigerant output from the compressor 26 and water (hereinafter, referred to as a “water-based coolant”) flowing toward the heater core 36. As will be described later, such a water-cooled gas cooler 28 includes a refrigerant flow passage 74 through which the air-conditioning refrigerant flows and a water flow passage 80 through which hot water flows. During heating operation, the high-temperature air-conditioning refrigerant is allowed to flow into the water-cooled gas cooler 28, thereby the water-based coolant and the heater core 36 are heated. The air passing through the heated heater core 36 is sent to the vehicle cabin, thereby the vehicle cabin is heated. A specific configuration of the water-cooled gas cooler 28 will be described in detail later.

The heater core 36 and the water-cooled gas cooler 28 are connected by a water circuit 35. The water circuit 35 is a circuit for circulating the water-based coolant. In addition to the heater core 36 and the water-cooled gas cooler 28, a water pump 37 and an electric heater 38 are also disposed in such a water circuit 35. The water pump 37 pumps the water-based coolant as needed. The electric heater 38 heats the water-based coolant to a target temperature in a case where the temperature of the water-based coolant output from the water-cooled gas cooler 28 is insufficient. In addition to or instead of the electric heater 38, another heat source may be provided. For example, waste heat generated by an in-vehicle heat generation element such as a battery, a motor, or an engine may be used as a heat source for heating the water-based coolant.

Further, a plurality of valves 56, 58, 60, 62 are provided in the refrigerant circuit 22. During cooling operation, a cooling expansion valve 56 and a cooling solenoid valve 60 are opened, while a heating expansion valve 58 and a heating solenoid valve 62 are closed. In this case, the air-conditioning refrigerant is pressurized by the compressor 26 and then flows through the air-cooled gas cooler 30, the internal heat exchanger 50, and the cooling expansion valve 56. The air-conditioning refrigerant that has passed through the cooling expansion valve 56 is in a low-pressure mist form and is supplied to the evaporator 44. In the evaporator 44, the air-conditioning refrigerant having a low-pressure mist form is evaporated, thereby air around the evaporator 44 is cooled. The cooled air is sent to the vehicle cabin by the blower fan 34, thereby the vehicle cabin is cooled. In the evaporator 44, the evaporated air-conditioning refrigerant having a gas form is sent to the accumulator 48 and is separated into a gas phase and a liquid phase. The air-conditioning refrigerant having a gas form is supplied to the compressor 26 again.

On the other hand, during heating operation, the heating expansion valve 58 and the heating solenoid valve 62 are opened, while the cooling expansion valve 56 and the cooling solenoid valve 60 are closed. In this case, the air-conditioning refrigerant is pressurized to a high temperature and a high pressure by the compressor 26 and then is supplied to the water-cooled gas cooler 28. In the water-cooled gas cooler 28, the water-based coolant and the heater core 36 are heated by the high-temperature and high-pressure air-conditioning refrigerant. Air passing through the high-temperature heater core 36 is sent to the vehicle cabin, thereby the vehicle cabin is heated. The air-conditioning refrigerant that has passed through the water-cooled gas cooler 28 is depressurized by the heating expansion valve 58 and then is sent to the air-cooled gas cooler 30. In the air-cooled gas cooler 30, the air-conditioning refrigerant receives heat from the outside air, and a part or all of the air-conditioning refrigerant is vaporized. The air-conditioning refrigerant is output from the air-cooled gas cooler 30 and then is separated into a gas phase and a liquid phase in the accumulator 48. The air-conditioning refrigerant having a gas form is supplied to the compressor 26 again.

As is clear from the above description, the air-conditioning device 20 includes a large number of components, and most of the components are disposed in the power unit compartment 10. In addition, in the power unit compartment 10, a power source, a transmission mechanism, and other components are disposed in addition to the air-conditioning device 20. Therefore, there is almost no spatial margin in the power unit compartment 10. In particular, as described above, in the present example, a CO2 refrigerant containing CO2 as a main component is used as the air-conditioning refrigerant. The CO2 refrigerant needs to be pressurized to a higher pressure than a fluorine-based refrigerant. In this case, the compressor 26 needs to adopt a large-output and large-sized compressor compared to a case where the fluorine-based refrigerant is used. As a result, in a case where the CO2 refrigerant is used, a spatial margin in the power unit compartment 10 is extremely small.

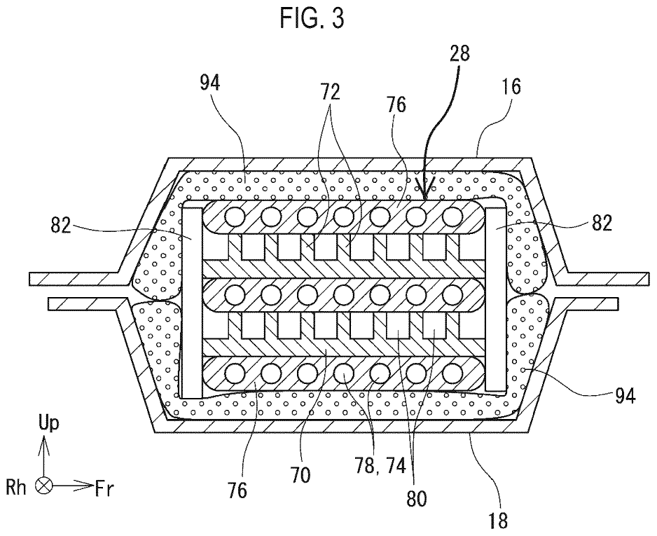

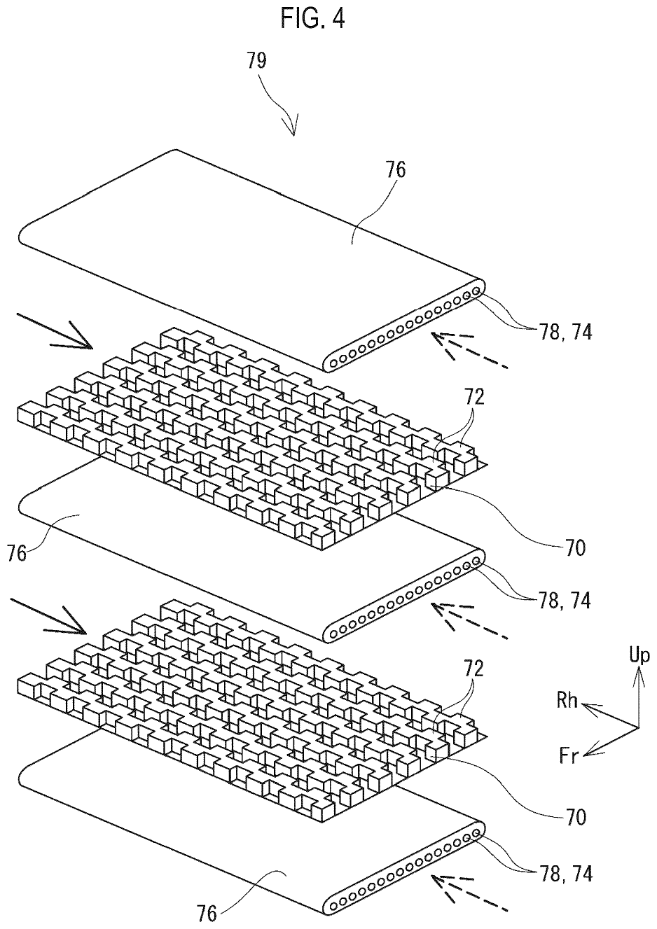

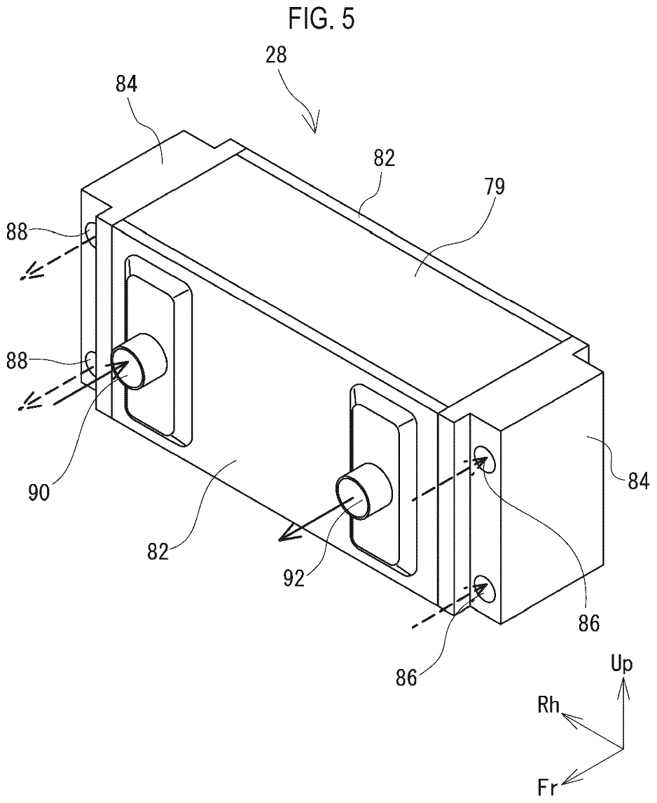

Therefore, in the present example, in order to effectively utilize the space of the power unit compartment 10, the water-cooled gas cooler 28 is disposed inside the tower bar 14. This will be described with reference to FIGS. 3 to 5. FIG. 3 is a cross-sectional view taken along line III-III in FIG. 1. In addition, FIG. 4 is an exploded perspective view of a main part of the water-cooled gas cooler 28, and FIG. 5 is a schematic perspective view of the water-cooled gas cooler 28.

The water-cooled gas cooler 28 includes fin plates 70 and tube plates 76 that are alternately arranged in an up-down direction. The fin plate 70 is formed of a metal having high thermal conductivity, such as aluminum. The fin plate 70 includes a plurality of fins 72 arranged at intervals in a vehicle front-rear direction. Each fin 72 alternately protrudes toward a front portion of the vehicle and a rear portion of the vehicle along the vehicle width direction. As a result, a passage that meanders in a zigzag shape is provided between the two fins 72 adjacent to each other in the vehicle front-rear direction. The passage serves as the water flow passage 80 through which the water-based coolant flows. Such a configuration of the fin plate 70 is an example and may be changed as appropriate. For example, the number of fins 72 and the shape of the fins 72 may be changed as appropriate.

The tube plate 76 is a plate-shaped member formed of a metal having a high thermal conductivity, for example, aluminum. The tube plate 76 is provided with a plurality of through-holes 78 that penetrate in the vehicle width direction at intervals in the vehicle front-rear direction. The through-holes 78 function as the refrigerant flow passage 74 through which the air-conditioning refrigerant flows.

The fin plates 70 and the tube plates 76 are alternately stacked in the up-down direction to form a stacked body 79. That is, in the water-cooled gas cooler 28, a layer of the refrigerant flow passage 74 and a layer of the water flow passage 80 are alternately stacked. A closure cover 82 is attached to both ends of the stacked body 79 in the vehicle front-rear direction. In order to prevent the air-conditioning refrigerant from leaking from the refrigerant flow passage 74 located at the end part in the vehicle front-rear direction, the closure cover 82 closes the refrigerant flow passage 74 at the end part in the vehicle front-rear direction. As shown in FIG. 5, a water inlet 90 and a water outlet 92 are mounted on the front closure cover 82. The water inlet 90 and the water outlet 92 are mounted in the vicinities of both ends of the front closure cover 82 in the vehicle width direction. Further, end plates 84 are disposed at both ends of the stacked body 79 in the vehicle width direction. A refrigerant inlet 86 is provided in one of the two end plates 84, and a refrigerant outlet 88 is provided in the other.

Inside the closure cover 82 and the end plates 84, a distribution flow passage (not shown) that causes the water-based coolant and the air-conditioning refrigerant supplied via the water inlet 90 and the refrigerant inlet 86 to branch into a plurality of the water flow passages 80 and the refrigerant flow passages 74 and guides the water-based coolant and the air-conditioning refrigerant is provided. In addition, inside the closure cover 82 and the end plates 84, a combining flow passage (not shown) that combines the water-based coolant and the air-conditioning refrigerant which have passed through the plurality of water flow passages 80 and the refrigerant flow passages 74 and guides the combined water-based coolant and air-conditioning refrigerant to the water outlet 92 and the refrigerant outlet 88 is also provided.

Here, the water-based coolant and the air-conditioning refrigerant flow in opposite directions to each other. A solid-line arrow in FIG. 4 indicates a direction in which the water-based coolant flows, and a broken-line arrow indicates a direction in which the air-conditioning refrigerant flows. In a case of the example in FIG. 4, the air-conditioning refrigerant flows from a right side to a left side of the drawing sheet, and the water-based coolant flows from the left side of the drawing sheet to the right side of the drawing sheet. In order to align with this flow, the water inlet 90 and the refrigerant inlet 86 are provided on the opposite sides in the left-right direction, and the water outlet 92 and the refrigerant outlet 88 are provided on the opposite sides in the left-right direction. That is, in the present example, the water inlet 90 and the refrigerant outlet 88 are provided in the vicinity of a left end part of the water-cooled gas cooler 28, and the refrigerant inlet 86 and the water outlet 92 are provided in the vicinity of a right end part of the water-cooled gas cooler 28.

As shown in FIGS. 1 and 3, the water-cooled gas cooler 28 is disposed inside the tower bar 14. This will be described specifically. As shown in FIG. 3, the tower bar 14 is configured by joining a tower bar upper 16 and a tower bar lower 18 to each other. A cross-sectional shape of the tower bar upper 16 is a substantially hat shape that is open on a lower side, and a cross-sectional shape of the tower bar lower 18 is a substantially hat shape that is open on an upper side. By stacking and joining portions corresponding to two “flanges” having the hat shapes, the tower bar 14 is configured. An inner space that is long in the vehicle width direction is provided between the tower bar upper 16 and the tower bar lower 18. That is, the tower bar 14 is a hollow member including a closed cross-sectional shape. In the present example, the water-cooled gas cooler 28 is disposed in the inner space. That is, the water-cooled gas cooler 28 is disposed inside the tower bar 14 in a posture in which a running direction of the refrigerant flow passage 74 and the water flow passage 80 is parallel to the vehicle width direction and a stacking direction of the fin plates 70 and the tube plates 76 is the up-down direction.

Here, the inner space of the tower bar 14 is a space that has not been utilized as a dead space in the related art. By disposing the water-cooled gas cooler 28 in such an inner space, space efficiency of the power unit compartment 10 is improved, and a mounting space for the large-sized compressor 26 can also be secured. In order for the water-cooled gas cooler 28 to exhibit sufficient performance, a flow passage distance of the refrigerant flow passage 74 and the water flow passage 80 needs to be sufficiently secured. In the present example, the running direction of the refrigerant flow passage 74 and the water flow passage 80 is parallel to a longitudinal direction of the tower bar 14. Therefore, the flow passage distance of the refrigerant flow passage 74 and the water flow passage 80 is easily secured, and heat exchange efficiency of the water-cooled gas cooler 28 can be improved.

As shown in FIG. 3, a gap between the water-cooled gas cooler 28 and an inner surface of the tower bar 14 is filled with an insulating material 94. The insulating material 94 is, for example, a foamed resin or felt. For example, an insulating material having a sheet shape before foaming may be attached to the inside of the tower bar 14, the water-cooled gas cooler 28 may be disposed inside the tower bar 14, and then the tower bar 14 may be heated to cause the insulating material to foam. With such a configuration, the insulating material expands in accordance with the shape of the water-cooled gas cooler 28, and thus the gap between the water-cooled gas cooler 28 and the inner surface of the tower bar 14 is appropriately filled with the insulating material.

In any case, the water-cooled gas cooler 28 is effectively insulated by filling the gap between the water-cooled gas cooler 28 and the inner surface of the tower bar 14 with the insulating material 94. As a result, heat used for heating is less likely to leak to the outside, thereby energy efficiency of the entire vehicle is improved. In addition, vibration of the water-cooled gas cooler 28 is suppressed by filling the gap with the insulating material 94. As a result, damage to the water-cooled gas cooler 28 is effectively prevented, and noise is also suppressed.

In addition, as repeatedly described, in the present example, the water-cooled gas cooler 28 is disposed inside the tower bar 14. The water-cooled gas cooler 28 is configured by stacking a plurality of metal components and is a component having high rigidity. By disposing such a water-cooled gas cooler 28 inside the tower bar 14, rigidity of the tower bar 14 is increased. As a result, driving stability of the vehicle is further improved.

As shown in FIG. 1, the water-cooled gas cooler 28 is disposed at a substantially center of the tower bar 14 in the vehicle width direction. Here, many of the components of the air-conditioning device 20 including the compressor 26 are disposed at the center of the vehicle in the vehicle width direction. Therefore, by disposing the water-cooled gas cooler 28 at the center in the vehicle width direction and providing the inlets 86, 90 and the outlets 88, 92 on both sides thereof, piping connections between the gas cooler and other elements can be simplified.

Piping of the refrigerant circuit 22 and piping of the water circuit 35 are connected to the water-cooled gas cooler 28. In order to connect these pieces of piping to the water-cooled gas cooler 28, an opening through which the piping can pass may be provided in the tower bar 14, for example, the tower bar lower 18. In addition, in a case where the water-cooled gas cooler 28 is disposed inside the tower bar 14, there is a concern that maintainability of the water-cooled gas cooler 28 may be reduced. Therefore, a maintenance opening may be provided in a part of the tower bar 14. In this case, the maintenance opening may have a size allowing the water-cooled gas cooler 28 to pass therethrough. In addition, the maintenance opening may be covered with a cover that is attachable to and detachable from the tower bar 14. For example, the cover may be fastened to the tower bar 14 with bolts.

In any case, as is clear from the description so far, the water-cooled gas cooler 28 is disposed inside the tower bar 14, and thus space efficiency of the power unit compartment 10 can be further improved. The configuration described so far is an example, and other configurations may be changed as long as the configuration of claim 1 is provided. For example, the insulating material 94 between the water-cooled gas cooler 28 and the tower bar 14 may not be provided. In addition, the configuration of the water-cooled gas cooler 28 may also be changed as appropriate. In addition, in the present example, the water-cooled gas cooler 28 is used for heating the vehicle cabin, but the water-cooled gas cooler 28 may be used for other purposes. For example, the water-cooled gas cooler 28 may be used for the purpose of cooling an in-vehicle component.

What is claimed is:

1. A vehicle front structure comprising:
a tower bar configured to connect left and right suspension towers in a front portion of a vehicle; and
a heat exchanger configured to exchange heat between an air-conditioning refrigerant used in an air-conditioning device and a water-based coolant, wherein:
the tower bar is a hollow member having a closed cross-sectional shape; and
the heat exchanger is disposed inside the tower bar.

2. The vehicle front structure according to claim 1, wherein:
the heat exchanger is a gas cooler in which a layer of a refrigerant flow passage through which the air-conditioning refrigerant flows and a layer of a water flow passage through which the water-based coolant flows are alternately stacked; and
the heat exchanger is disposed inside the tower bar in a posture in which a running direction of a flow passage of the air-conditioning refrigerant and a longitudinal direction of the tower bar are substantially parallel to each other.

3. The vehicle front structure according to claim 2, wherein:
the gas cooler is disposed substantially at a center of the tower bar in a vehicle width direction; and
an inlet and an outlet for each of the air-conditioning refrigerant and the water-based coolant are provided at both ends of the gas cooler in the vehicle width direction.

4. The vehicle front structure according to claim 1, wherein:
the air-conditioning device is configured to perform heating using heat transferred from the air-conditioning refrigerant to the water-based coolant in the heat exchanger; and
a space between the heat exchanger and an inner surface of the tower bar is filled with an insulating material.
